(19) United States
(12) Patent Application Publication
(10) Pub. No.: US 2019/0370738 A1
(43) Pub. Date: Dec. 5, 2019

(54) METHODS AND APPARATUS FOR WIRELESS INVENTORY DETERMINATIONS

(71) Applicant: Fellow, Inc., Burlingame, CA (US)

(72) Inventors: Marco Octavio Mascorro Medina, Burlingame, CA (US); Thavidu Ranatunga, Burlingame, CA (US); Utkarsh Sinha, Burlingame, CA (US); Sivapriya Kaza, Burlingame, CA (US); Zhengqin Fan, Burlingame, CA (US)

(21) Appl. No.: 16/546,150

(22) Filed: Aug. 20, 2019

Related U.S. Application Data
(63) Continuation-in-part of application No. 16/457,647, filed on Jun. 28, 2019.
Application No. 16/457,647 is a continuation-in-part of application No. 16/138,758, filed on Sep. 21, 2018, now Pat. No. 10,373,116.
Application No. 16/138,758 is a continuation-in-part of application No. 15/369,812, filed on Dec. 5, 2016, now Pat. No. 10,311,400.
Application No. 15/369,812 is a continuation-in-part of application No. 14/921,899, filed on Oct. 23, 2015, now Pat. No. 9,796,093.
(60) Provisional application No. 62/068,474, filed on Oct. 24, 2014.
(60) Provisional application No. 62/622,000, filed on Jan. 25, 2018.
(60) Provisional application No. 62/561,588, filed on Sep. 21, 2017.
(60) Provisional application No. 62/795,152, filed on Jan. 22, 2019.
(60) Provisional application No. 62/740,793, filed on Oct. 3, 2018.

(51) Int. Cl. G06Q 10/08; H04W 4/38; G06N 20/00

(52) U.S. Cl. CPC G06Q 10/087; H04L 67/10; G06N 20/00; H04W 4/38

(57) ABSTRACT

Methods and apparatus for making wireless inventory determinations are disclosed. An apparatus includes a signal generator, which generates a millimeter wave signal having an initial frequency substantially between 30 GHz and 300 GHz, and a transmitter in communication with the signal generator. The transmitter transmits the millimeter wave signal to at least one inventory item in a commercial facility. The transmitted millimeter wave signal is reflected off of the inventory item. A receiver receives a reflected millimeter wave signal from the at least one inventory item. A processor is in communication with the receiver and the signal generator. The processor determines at least one of: a location, count, orientation, and type of the at least one inventory item by using the reflected millimeter wave signal. The determination is based on a comparison of the reflected millimeter wave signal with the transmitted millimeter wave signal.

### CROSS REFERENCE TO RELATED APPLICATION

This application is a continuation-in-part of U.S. patent application Ser. No. 16/457,647 filed Jun. 28, 2019, which in turn is a continuation-in-part of U.S. patent application Ser. No. 16/138,758 filed Sep. 21, 2018, now U.S. Pat. No. 10,373,116 issued Aug. 6, 2019, which in turn is a continuation-in-part of U.S. patent application Ser. No. 15/369,812 filed Dec. 5, 2016, now U.S. Pat. No. 10,311,400 issued Jun. 4, 2019, which in turn is a continuation-in-part of U.S. patent application Ser. No. 14/921,899 filed Oct. 23, 2015, now U.S. Pat. No. 9,796,093 issued Oct. 24, 2017, which claims the benefit of U.S. Provisional Application Ser. No. 62,/068,474 filed Oct. 24, 2014. U.S. application Ser. No. 16/138,758 also claims the benefit of U.S. Provisional Application Ser. Nos. 62/622,000 filed Jan. 25, 2018 and 62/561,588 filed Sep. 21, 2017. U.S. patent application Ser. No. 16/457,647 also claims the benefit of U.S. Provisional Application Ser. No. 62/795,152 filed Jan. 22, 2019. This application claims the benefit of U.S. Provisional Application Ser. No. 62/740,793 filed Oct. 3, 2018, the entire disclosures of which are incorporated herein by reference.

### FIELD OF THE DISCLOSURE

The present disclosure is generally related to inventory determinations, and is more particularly related to methods and apparatus for inventor determinations using wireless sensors.

### BACKGROUND

For most retail stores and commercial facilities, inventory management is a complex, time-consuming, and expensive issue. Large stores can carry more than 10,000 items on shelves. These items must be tagged, tracked, displayed, restocked, and priced on a regular basis to ensure product availability to customers. Additionally, most stores maintain backroom inventories where items used to replenish display stock are kept. These backroom inventories must also be accurately tracked. Backroom inventories are replenished by periodic stock deliveries, which must also be tracked.

Inventory stocking is the process of placing items out on shelves or in displays such that they can be purchased by customers. Restocking is the process of replenishing items that have been purchased, moved, stolen, or damaged. Stocking and restocking are time-consuming tasks, since they normally entail the detailed review of all products for sale. Traditionally, store employees travel each aisle, noting the number and location of depleted or missing items. They gather new inventory from a backroom storage area, then travel each aisle again, replenishing low stock with new inventory. Depending on the store, this process can take dozens of employees and many hours to complete. Often, restocking must be done after a store has closed or late at night. This can leave shelves understocked for long periods during business hours. Additionally, the process can require additional employees working an overnight shift to complete restocking before the opening of the store the next day.

Another drawback of the conventional inventory process is that it can be difficult to collect accurate loss prevention data. Employees may only realize that items have been stolen when restocking late in the day. This makes it difficult to analyze when theft occurred or tailor loss prevention policies to specific items and areas.

While employees are restocking inventory on shelves, they often must concurrently perform quality assurance checks. Employees ensure that all items are properly located, returning moved and misplaced items to their appropriate areas. Often, this means traveling the entire store in search of misplaced items and subsequently placing the misplaced items in their correct locations. Additionally, employees must also ensure that items are oriented neatly, with price tags and labels visible.

Additionally, many franchise or branch stores are required to stock and display products in a manner determined by a corporate office. Such information is usually displayed in the form of a planogram: a diagram that indicates the placement of products in a shelf and in a store. Planogram compliance can be inaccurate for a number of reasons, including human error in reading the diagram, differences in store layout, inattention to placement details, and changes in product packaging. However, planogram compliance is important to ensure consistency between stores and to present products for sale according to a chosen strategic plan. If stores do not stock and display products accurately, the data upon which corporate offices analyze sales and create strategic placement plans is likely to be inaccurate.

Another issue in performing inventory determinations is that they require visual confirmation. Employees must visually confirm the status, count, orientation, and type of items before they can be tracked. This can be difficult where vision is hindered: on tall or deep shelves, in dark areas of a facility, where items are located in packaging or shipping vehicles, or when items are difficult to count, such as screws and small hardware. Such scenarios require employees to expend additional time and effort visually verifying the presence and layout of inventory items. When items are received in deliveries from shipping vehicles, it may be impossible for employees to verify the contents of the shipment until well after the delivery person has left. This can cause delays in stocking, low stock, or out-of-stock occurrences, which hinder customer service efforts.

Current solutions to these problems utilize inventory management software, point of sale systems, and tracking devices to manage inventory. However, the implementation of these solutions is largely dependent on data acquired manually. This data can be inconvenient to collect, time-consuming to gather, and inaccurate.

Thus, a heretofore unaddressed need exists in the industry to address the aforementioned deficiencies and inadequacies.

### SUMMARY OF THE DISCLOSURE

Embodiments of the present disclosure provide multiple intelligent improvements in devices and methods for wireless inventory determinations.

In one embodiment, an apparatus for making inventory determinations is provided. The apparatus includes a signal generator, which generates a millimeter wave signal having an initial frequency substantially between 30 GHz and 300 GHz, and a transmitter in communication with the signal generator. The transmitter transmits the millimeter wave signal to at least one inventory item in a commercial facility. The transmitted millimeter wave signal is reflected off of the inventory item. A receiver receives a reflected millimeter wave signal from the at least one inventory item. A processor is in communication with the receiver and the signal generator. The processor determines at least one of: a location, a count, an orientation, and a type of the at least one inventory item by using the reflected millimeter wave signal. The determination is based on a comparison of the reflected millimeter wave signal with the transmitted millimeter wave signal.

In another embodiment, the present disclosure can also be viewed as providing methods of inventorying at least a portion of a quantity of inventory items in a commercial facility with an electronic inventory apparatus. In this regard, one embodiment of such a method, among others, can be broadly summarized by the following steps: generating, with a signal generator, a detection signal having an initial frequency substantially between 30 GHz and 300 GHz; transmitting, with at least one antenna in communication with the signal generator, the detection signal to at least one inventory item; receiving, with the at least one antenna, a reflected signal from the at least one inventory item; comparing, with a processor in communication with the at least one antenna, the reflected signal with the detection signal to determine a difference between the reflected and detection signals; determining, with the processor, at least one of: a location, a count, an orientation, and a type of the at least one inventory item, wherein the determination is made based on the difference between the reflected and detection signals; calculating, with the processor, a confidence level for the determination; and communicating, with a transmitter in communication with the processor, at least a portion of the determination and the confidence level to a database.

In another embodiment, the present disclosure can also be viewed as providing a method of inventorying at least partially non-visible inventory items, comprising the steps of generating, with a signal generator, a detection signal having an initial frequency substantially between 30 GHz and 300 GHz; transmitting, with at least one antenna in communication with the signal generator, the detection signal to a plurality of at least partially non-visible inventory items located within an inventory area, wherein the detection signal is reflected off of the plurality of at least partially non-visible inventory items; receiving, with the at least one antenna, the reflected signal from the plurality of at least partially non-visible inventory items; comparing, with a processor in communication with the at least one antenna, the reflected signal with the detection signal to determine a difference between the reflected and detection signals; determining, with the processor, at least one of: a location, a count, an orientation, and a type of the plurality of at least partially non-visible inventory items; calculating, with the processor, a confidence level for the determination; and communicating, with a transmitter in communication with the processor, at least a portion of the determination and the confidence level to a database.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic illustration of an apparatus for performing inventory management within a commercial facility, in accordance with a first embodiment of the disclosure.

FIGS. 2A-2C show exemplary embodiments of the apparatus for performing inventory management within a commercial facility.

FIG. 3 is a flow chart showing a method of inventorying at least a portion of a quantity of inventory items in a commercial facility with an electronic inventory apparatus, in accordance with a second embodiment of the disclosure.

FIG. 4 is a flow chart showing an exemplary process for determining the inventory characteristics of at least one inventory item, in accordance with a second embodiment of the disclosure.

FIG. 5 is a flow chart showing an exemplary process for determining a confidence level for the inventory information using the method of FIG. 3

FIG. 6 is a flow chart showing a method of inventorying at least partially non-visible items, in accordance with a third embodiment of the disclosure.

FIGS. 7A-7B show exemplary embodiments of the method of FIG. 6 in use to inventory at least partially non-visible items.

### DETAILED DESCRIPTION

In the following description, reference is made to the accompanying drawings, which form a part hereof, and in which is shown, by way of illustration, various embodiments of the present disclosure. It is understood that other embodiments may be utilized and changes may be made without departing from the scope of the present disclosure.

Many aspects of the invention may take the form of computer-executable instructions, including algorithms executed by a programmable computer. Those skilled in the relevant art will appreciate that the invention can be practiced with other computer system configurations as well. Certain aspects of the invention can be embodied in a special-purpose computer or data processor that is specifically programmed, configured or constructed to perform one or more of the computer-executable algorithms described below. Accordingly, the term “computer” as generally used herein refers to any data processor and includes Internet appliances, hand-held devices (including palm-top computers, wearable computers, cellular or mobile phones, multi-processor systems, processor-based or programmable consumer electronics, network computers, minicomputers) and the like.

Some aspects of the invention may also be practiced in distributed computing environments, where tasks or modules are performed by remote processing devices that are linked through a communications network. In a distributed computing environment, program modules or subroutines may be located in both local and remote memory storage devices. Aspects of the invention described below may be stored or distributed on computer-readable media, including magnetic and optically readable and removable computer disks, fixed magnetic disks, floppy disk drive, optical disk drive, magneto-optical disk drive, magnetic tape, hard-disk drive (HDD), solid state drive (SSD), compact flash or non-volatile memory, as well as distributed electronically over networks. Data structures and transmissions of data particular to aspects of the invention are also encompassed within the scope of the invention.

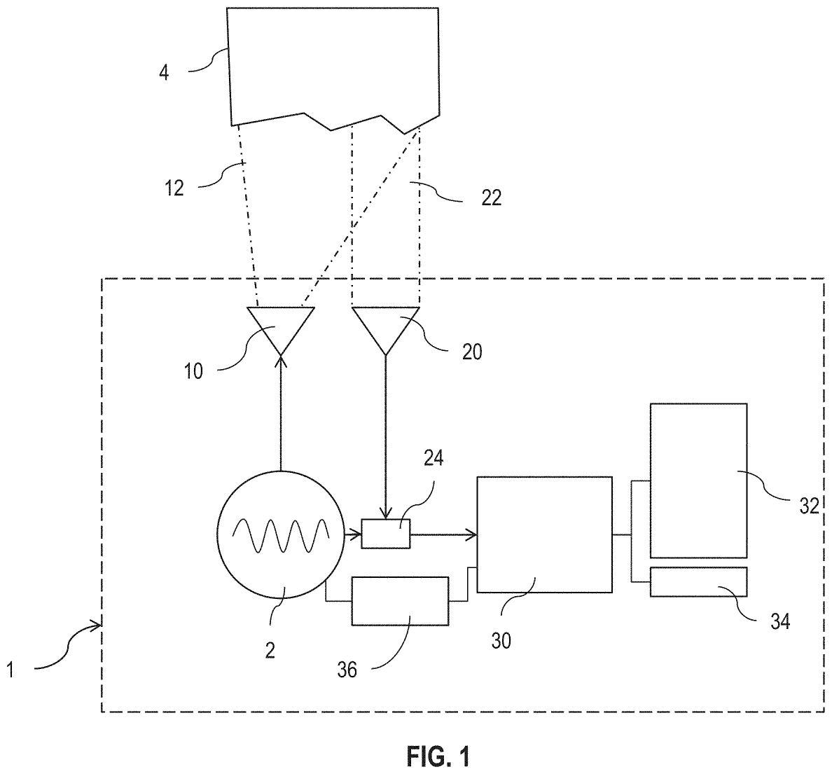

FIG. 1 is a schematic illustration of an apparatus 1 for performing inventory management within a commercial facility, in accordance with a first embodiment of the disclosure. The apparatus 1 includes a signal generator 2, which generates a millimeter wave signal 12 having an initial frequency substantially between 30 GHz and 300 GHz, and a transmitter 10 in communication with the signal generator 2. The transmitter 10 transmits the millimeter wave signal 12 to at least one inventory item 4 in a commercial facility. The transmitted millimeter wave signal 12 is reflected off of the inventory item 4. A receiver 20 receives a reflected millimeter wave signal 22 from the at least one inventory item 4. A processor 30 is in communication with the receiver 20 and the signal generator 2. The processor 30 determines at least one of: a location, a count, an orientation, and a type of the at least one inventory item 4 by using the reflected millimeter wave signal 22. The determination is based on a comparison of the reflected millimeter wave signal 22 with the transmitted millimeter wave signal 12.

The signal generator 10 may be any device, synthesizer, or material suitable for generating a millimeter wave signal 12. Millimeter waves generally correspond to the radio band of the electromagnetic spectrum between 30 GHz and 300 GHz, also known as the extremely high frequency (EHF) range. Depending on intended use and implementation, signal generators operating in the super hi frequency (SHF) range or in the far infrared (FIR) range may be considered within the scope of this disclosure. For the purposes of this disclosure, all waves having frequencies between substantially 30 GHz and substantially 300 GHz, or having wavelengths on the order of 1 millimeter, will be referred to as “millimeter waves.”

In one example, the millimeter wave signal 12 generated by the signal generator 10 may have a constant frequency for the duration of the signal. In another example, the frequency of the millimeter wave signal 12 may vary. For instance, the frequency of the millimeter wave signal 12 may increase or decrease linearly as a function of time, having a bandwidth of several GHz. The initial frequency of the millimeter wave signal 12 may be, for example, 50 GHz, and may increase linearly to a final frequency of 55 GHZ. In another example, the frequency of the millimeter wave signal 12 may be modulated non-linearly as a function of time, for instance, sinusoidally, as a step function, logarithmically, and the like. The modulation pattern of the frequency may be chosen to achieve a desired resolving power, operating distance, or other detection characteristic.

In another example, the millimeter wave signal 12 may comprise multiple chirps, or short bursts of millimeter waves in rapid succession. These chirps may be made of waves of constant or modulated frequencies. Chirps may be identical repeated signals, or they may vary from chirp to chirp. In one example, the millimeter wave signal 12 may comprise a repeating series of chirps.

The apparatus 1 may further include a power source 36 connected to the signal generator 2 and the processor 30. The power source 36 may be any suitable source of alternating or direct current, for example, a battery. In one example, the battery may be rechargeable as is known in the art, or it may be a disposable, one-time use battery. In other examples, the power source 36 may include a hard-wired connection.

After the millimeter wave signal 12 is generated, it is transmitted by a transmitter 10 in communication with the signal generator 2. The transmitter 10 may be any antenna suitable for propagating the millimeter wave signal 12. The transmitted millimeter wave signal 12 is transmitted to at least one inventory item 4 in a commercial facility.

Inventory items may be any type, number, and grouping of stock, products, or other items for which tracking or accounting is desired. In one example, inventory items may be located within shipping containers, packaging, pallets, boxes, shopping carts or bags, and the like. In another example, inventory items may be located on shelves, stacks, piles, displays, drawers, and the like. A commercial facility may be any place where inventory items are located, such as a manufacturing facility, warehouse, store, shipping yard, shipping vehicle, and the like.

The transmitted millimeter wave signal 12 (hereinafter “transmitted signal”) is reflected off of the inventory item 4. A portion of the reflected millimeter wave signal 22 (hereinafter “reflected signal”) is received by a receiver 20 on the apparatus 1. The receiver 20 may be any antenna suitable for detecting the reflected signal 22. In one example, the receiver 20 may share some or all components with the transmitter 10. In another example, the receiver 20 and the transmitter 10 may be separate components. In yet another example, the apparatus 1 may comprise a plurality of transmitters 10 and/or a plurality of receivers 20. For instance, the apparatus 1 may comprise two transmitters 10 and 4 receivers 20, which may provide increased resolution, field of view, or detection bandwidth. Additionally, the use of multiple receivers 20 located offset from one another may provide improved dimensional detail relative to a single receiver 20, allowing the apparatus 1 to create 2-dimensional and 3-dimensional representations of inventory items 4.

The receiver 20 is in communication with a processor 30. The apparatus 1 may have one or more processors 30 working in serial or in parallel. The processor 30 may be. for example. an Arduino Mega microcontroller. which allows for easy development along with serial output. and may act as a serial (e.g.. via USB) device that provides an interface to the apparatus 1. The processor 30 may be any processor. microprocessor or microcontroller. and may be a PIC microcontroller. which is generally powerful and allows for high speed USB and Ethernet connections for data transfer. The processor 30 may include or be associated with some amount of computer-readable memory 32, including RAM, cache memory, hard drives (HDDs), and solid state drives (SSDs). The memory 32 may provide temporary storage (working memory) for processing or permanent storage of signals, computations, and results.

The transmitted signal 12 may be split and one arm of the signal directed to the processor 30, while the other is sent to the transmitter 10. In one example, the apparatus 1 may include a mixer 24 which combines the transmitted and reflected signals 12, 22 before they arrive at the processor 30. In another example, the processor 30 may combine the transmitted and reflected signals 12, 22 without the help of a mixer 24. In yet another example, the signal generator 2, transmitter 10, receiver 20, mixer 24, and processor 30 may be combined into one system on chip (SoC) device. For instance, the Texas Instruments IWR 1443 is an integrated single-Chip millimeter wave sensor capable of operating in the 76-81 GHz band with up to a 4 GHz chirp bandwidth.

The processor 30 determines at least one of a location, a count, an orientation, and a type of the at least one inventory item 4 using the reflected signal 22. The determination is based on a comparison of the reflected signal 33 with the transmitted signal 12. Where the signals 12, 22 are mixed, either by the mixer 24 or the processor 30, the comparison may be the difference in amplitude, frequency, polarization state, or phase as a function of time. The differences may indicate the item's distance from the apparatus, orientation, material characteristics, or other characteristics. For instance, the amplitude difference of a transmitted signal 12 with constant or linearly varying amplitude and the corresponding reflected signal 22 may be determined by the processor 30. The phase difference of a transmitted signal 12 with a sinusoidally modulated amplitude and its corresponding reflected signal 22 may indicate an inventory item 4′s distance and angle from the apparatus 1. The frequency difference of a transmitted signal 12 with a modulated frequency and its corresponding reflected signal 22 may indicate the presence of certain materials or items over others. The polarization state difference of a transmitted signal 12 and its corresponding reflected signal 22 may indicate a change in material. Any combination of these differences may be analyzed in conjunction to determine characteristics of the inventory item 4. Additionally, other known signal processing operations may be performed, such as adding, multiplying, differentiating, time-shifting, and the like.

In implementation, the determination of the inventory item 4's characteristics may vary, depending on use. In one example, a user of the apparatus 1 may desire to know the count, or number, of items in a particular area. Therefore, the apparatus 1 may only detect discrete items and present a count resulting from a scan. In another example, a user may desire to know the orientation of items in order to maintain a display area neat and orderly. The apparatus 1 may detect characteristics of inventory items 4 indicating whether they are facing straight, upright, angled, and the like, and/or they may indicate whether the items are facing in a specific direction based on the material of a labeling of a product, and may present orientation results to the user. In another example, a user may desire the location of items, for example, where several inventory items 4 are located in close proximity and visual detection is difficult, such as when inventory items are housed within shipping boxes, positioned inset within a shelf and behind other products, and/or positioned in other locations with difficult visibility. The apparatus 1 may detect characteristics pertaining to the relevant items 4 and may present location results to the user. In another example, a user may desire to know some combination of characteristics, and may direct the apparatus accordingly.

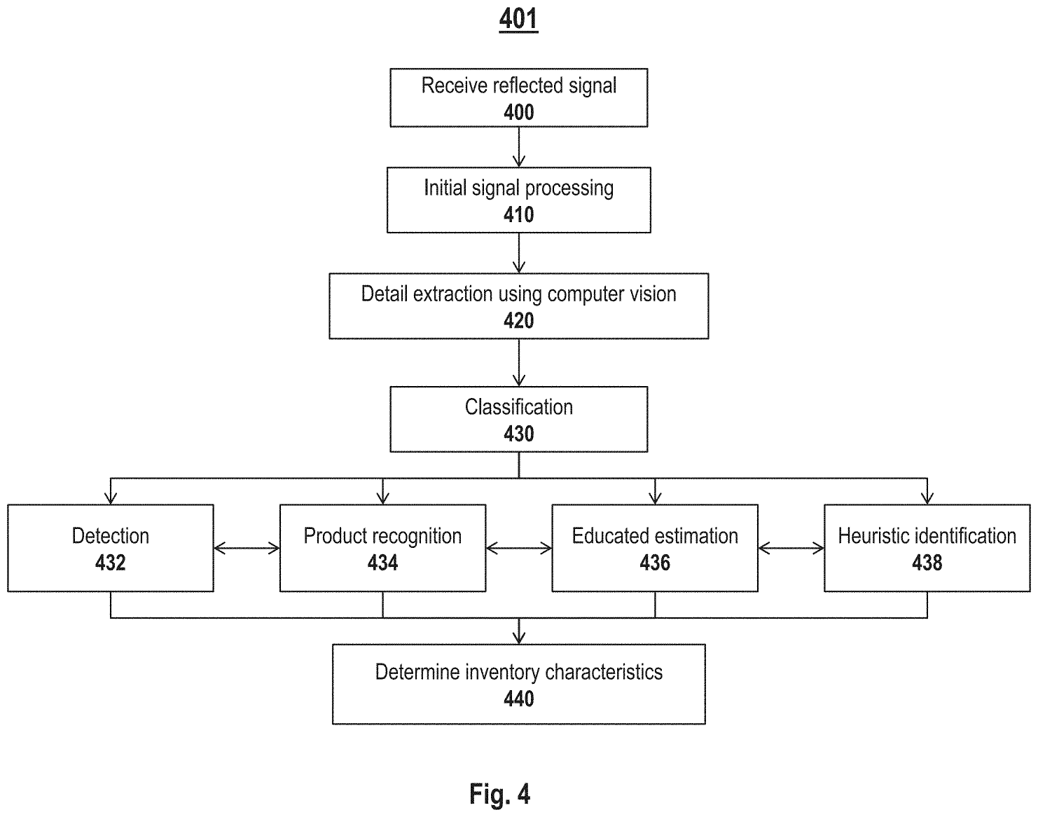

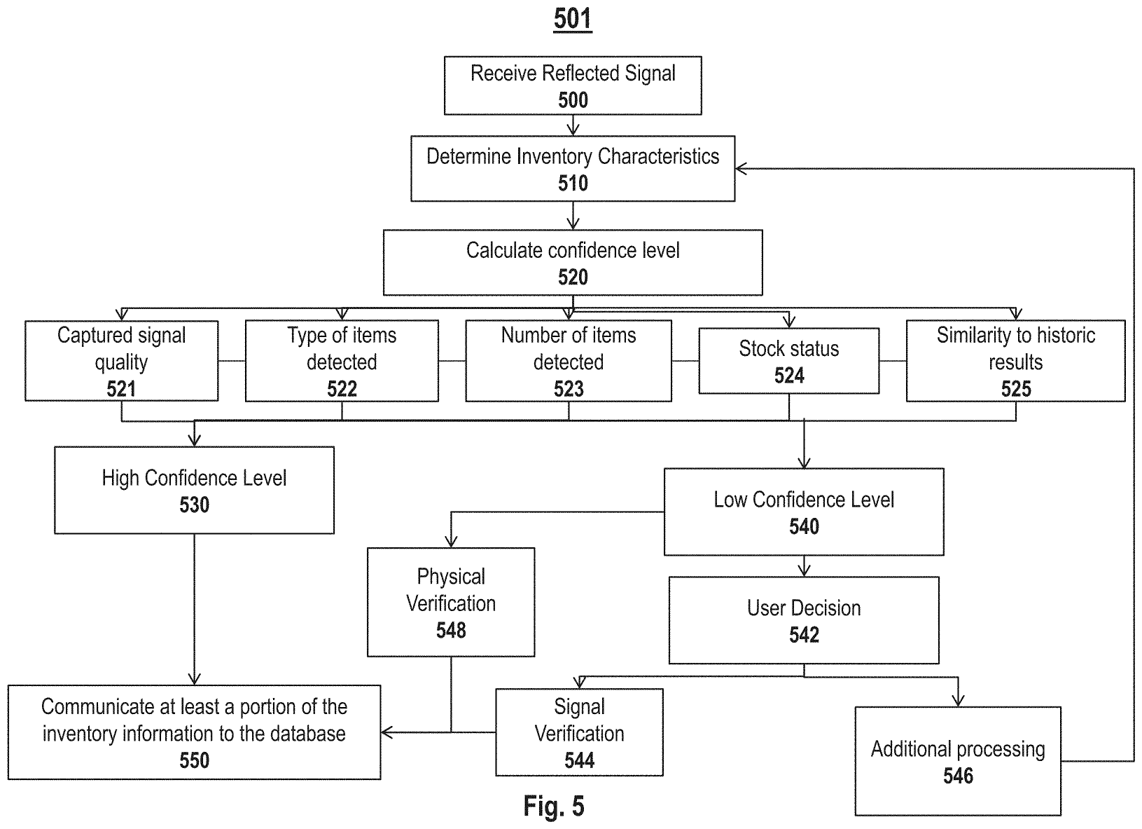

The processor 30 may employ a number of processing techniques to determine the inventory characteristics. In one example, the processor may use computer-vision, neural network, machine learning, or deep learning techniques to extract features of inventory items 4, learn and apply identification rules to processed signals, and determine inventory characteristics within a desired confidence level. These techniques are discussed further in FIGS. 4 and 5, below.

The apparatus 1 may include additional components, such as a display and user input interface. The display may be any visual display, including screens, indicator lights, switches, dials, and the like. In one example, the display may be a screen which indicates the characteristics of the inventory item 4 to the user by graphical user interface (GUI). The display may be in communication with the processor 30, and may be in communication with additional graphics or display processors as needed. The user input interface may allow the user to enter scan parameters, save information, and otherwise direct the operation of the apparatus 1. The user input interface may include buttons, keys, dials, switches, a keyboard, and the like. The display and the user input interface may work together during operation of the apparatus 1. For instance. the display may prompt the user to select a scan parameter. such as an inventory characteristic to be determined. The user may type or select an inventory characteristic using the user input interface. The apparatus 1 may perform a scan and may display the results to the user on the display. The user may use the user input interface to save the results or scan again.

The apparatus 1 may also include an information transmitter 34, which may be a transmitter or a transceiver. The information transmitter 34 may transmit the results of any signal processing to another device, such as a computer, server, or database. The transmission or reception may utilize one or more wireless protocols, such as Wi-Fi®, Bluetooth®, cellular networks, near-field communications (NFC), and the like. The wireless protocol may connect the apparatus 1 to a local machine, intranet network, or the Internet. In one example, the information transmitter 34 may transmit to a cloud database for further processing, analysis, or storage. In another example, the information transmitter 34 may receive data from a cloud database to assist the apparatus 1 in detecting inventory item characteristics. This technique is discussed further below.

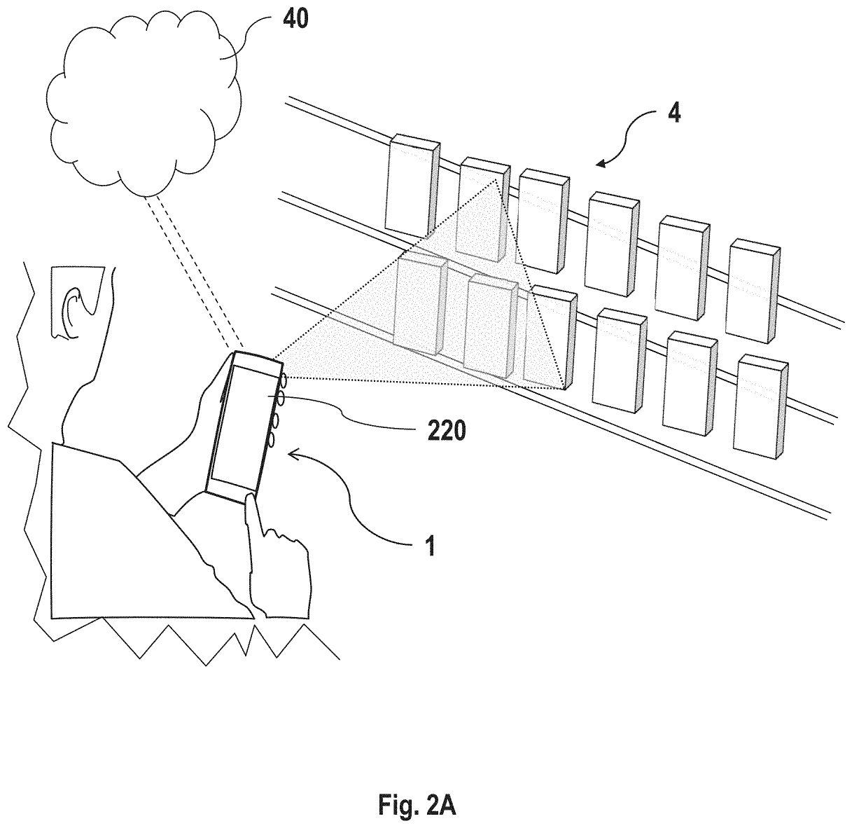

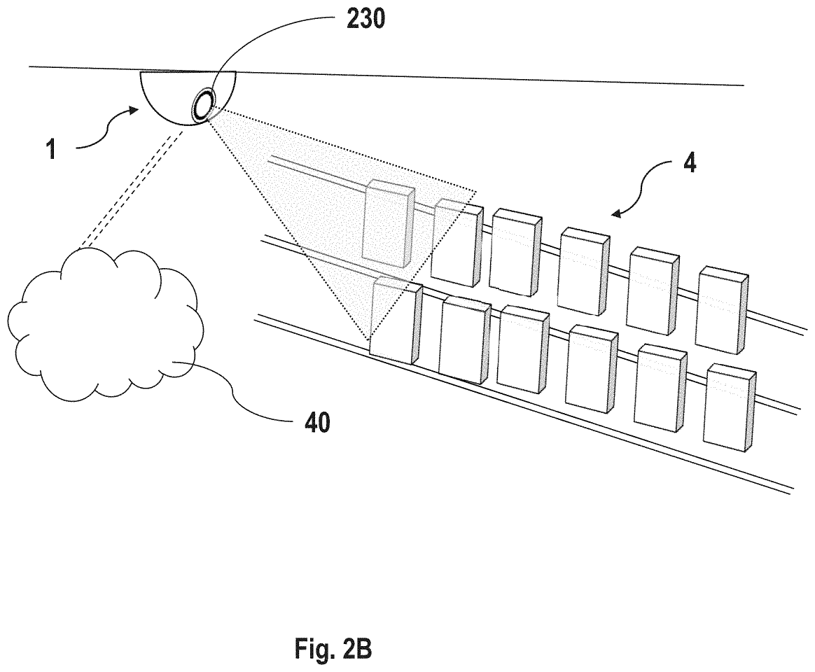

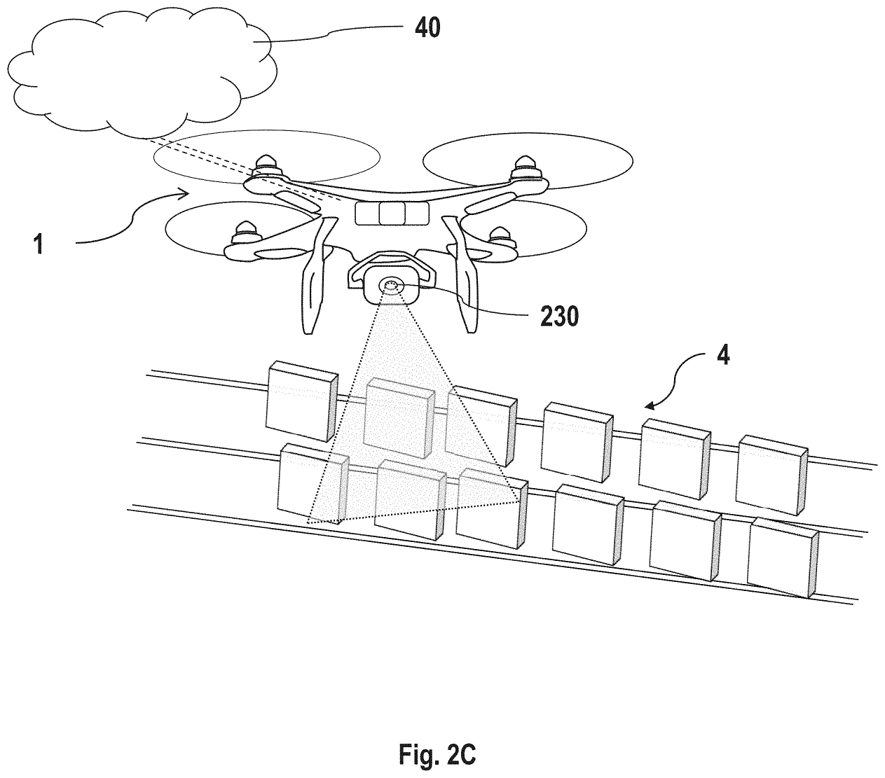

FIGS. 2A-2C show exemplary embodiments of the apparatus 1 for performing inventory management within a commercial facility.

In FIG. 2A, the apparatus 1 is shown as a handheld device. The apparatus 1 may be embodied as any handheld device, such as a smartphone, smartwatch, tablet, laptop, scanning gun, and the like. A smartphone is shown as an example. The components discussed in FIG. 1 may be common to or combined with the components of the smartphone or tablet. For example, the processor 30, memory 32, information transmitter 34, and power source 36 are commonly used in smartphones. The remaining components (signal generator 2, transmitter 10, receiver 20, and mixer 24) may be combined with the smartphone to create the apparatus 1. As shown in FIG. 2A, a user may hold the apparatus 1 in hand and direct it to perform an inventory scan of the inventory items 4, sending the transmitted signal 12, receiving the reflected signal 22, and processing. A screen 220 may provide textual or graphical results of the scan and allow the user to save, perform another scan, or adjust scan parameters. The apparatus 1 may upload the results of the scan to a cloud database 40 using a wireless protocol.

FIG. 2B shows the apparatus 1 as a fixed device. The fixed device may be placed in a variety of locations, including on shelves, walls, pillars, ceilings, and the like. Multiple such devices may be placed throughout a commercial facility to obtain desired coverage of the facility. In particular, the apparatus 1 is shown in a housing mounted to the ceiling of a commercial facility. The housing may be stationary, and may only be able to scan a predetermined portion of the commercial facility. In one example, the housing may rotate up to 360° to allow the apparatus 1 to scan a larger portion of the commercial facility. The apparatus 1 may scan the inventory items 4 through an opening 230 transparent to allow millimeter waves in and out. The apparatus 1 may be remotely operated or automated to perform inventory assessments at specific times. Once the apparatus 1 has completed an inventory assessment scan, it may upload any results to a cloud database 40 using a wireless protocol. Alternatively, the apparatus 1 of this embodiment may use any wired protocol to send and receive information from a connected network.

FIG. 2C shows the apparatus as a robotic device. The robotic device may include a number of form factors, for instance, humanoid, drone, and vehicle. In particular, the apparatus 1 is shown as a flying drone. The drone may fly over and through shelves in a commercial facility in order to perform inventory assessments of any inventory items 4. Other form factors may use different locomotive elements, such as feet or wheels. The apparatus 1 may scan the inventory items 4 through an opening 230 transparent to allow millimeter waves in and out. The apparatus 1 may be remotely operated or automated to perform inventory assessments at specific times. Once the apparatus 1 has completed an inventory assessment scan, it may upload any results to a cloud database 40 using a wireless protocol.

The embodiments shown in FIGS. 2A-2C may include additional processors, batteries, and motors used to control and power the apparatus 1 as it moves through the commercial facility. The apparatus 1 may further include location detection, for example, through the information transmitter 34. Location detection may utilize any of a number of known location detection techniques, including Global Positioning System (GPS), Indoor Positioning System (IPS) and Inertial Navigation System (INS), to detect the location of the apparatus 1 in the commercial facility. Location detection may also function in coordination. with any number of maps, floorplans, or similar schematics of a layout of the facility in which the apparatus 1 is utilized.

The apparatus 1 may include additional imaging sensors, environmental sensors, or hazard sensors. These sensors may include visible cameras, infrared cameras, sonar, LIDAR, radar, or other object detection systems. Additional sensors may allow the apparatus 1 to confirm inventory characteristics, read barcodes or labels, and avoid obstacles while navigating through the commercial facility. These additional sensors may be located on the apparatus 1 or fixed at designated points within the facility. The apparatus 1 may use the additional imaging sensors in combination with the signal generator 2 in order to provide detailed imaging containing labels or barcodes and inventory characteristics.

In one example, data from any combination of fixed sensors and signal generators 2 may be compared to pre-existing, planned data provided through planograms or other inventory layout reports. The data from the planograms may be used to guide the processor 30 in identifying and resolving the real-world inventory using the sensors and signal generator 2. If the processor 30 is identifies an item with low confidence, or is unable to identify an item at all, the planned data may suggest possible items, along with identifying characteristics, which may assist the processor 30 in identifying the unknown item. This may improve the recognition capability of the apparatus 1.

In one example, the apparatus 1 may use optimization techniques to identify inventory items based on previous results. For instance, the apparatus 1 may compare a presently-captured image or series of images against one or more historical images the same area, aisle, or shelf within the facility. The apparatus 1 may look for differences between the presently-captured image and the historical image. Portions that are the same between the presently-captured and historical images may not be further analyzed or may be analyzed with reduced scrutiny, detail, or resolution. Portions that are different between the presently-captured and historical images may be analyzed in greater detail, for instance with additional imaging, close-up imaging, multi-sensory imaging using a combination of sensors, human intervention, and the like. This may be particularly effective with fixed position sensors, which can easily match the field of view of historical and presently-captured images. However, the processor 30 may also perform image alignment when non-fixed sensors are used. These techniques may reduce the time and processing power required to perform inventory analysis, as the apparatus 1 will only need to analyze the portions of the images with changes. In another example, the apparatus 1 may increase the resolution and clarity of presently-captured images by taking a number of multiple images in series, then combining the resulting images. Image characteristics such as light intensity may be averaged to reduce noise, resulting in higher quality images. Additionally, techniques may be used to increase the dynamic range, contrast, color separation, and the like in order to better resolve items within the image.

In one example, multiple apparatuses 1 may be used to inventory a commercial facility. For instance, multiple employees may use a handheld device as in FIG. 2A, going up and down aisles and scanning shelves and displays.

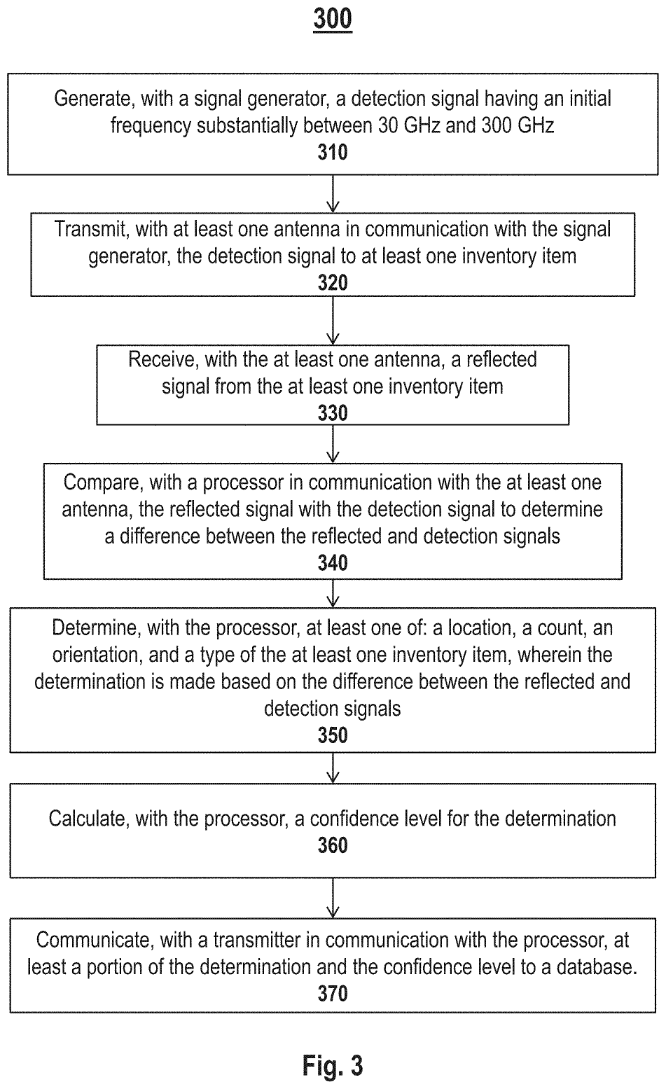

FIG. 3 is a flow chart 300 showing a method of inventorying at least a portion of a quantity of inventory items in a commercial facility with an electronic inventory apparatus, in accordance with a second embodiment of the disclosure. The method may be performed with the apparatus 1 of FIG. 1 and any of the exemplary embodiments of FIGS. 2A-2C, or it may be performed using other suitable hardware and software components. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

Step 310 includes generating, with a signal generator, a detection signal having an initial frequency substantially between 30 GHz and 300 GHz.

Step 320 includes transmitting, with at least one antenna in communication with the signal generator, the detection signal to at least one inventory item.

Step 330 includes receiving, with the at least one antenna, a reflected signal from the at least one inventory item. As discussed relative to FIG. 1, the transmitting and receiving antennas may be the same antenna alternating between transmit and receive functions, or separate antennas dedicated specifically to a transmit or a receive function.

Step 340 includes comparing, with a processor in communication with the at least one antenna, the reflected signal with the detection signal to determine a difference between the reflected and detection signals. In one example, after performing this step, the reflected and detected signals may be stored on computer-readable memory. In another example, the difference determination may be stored.

Step 350 includes determining, with the processor, at least one of: a location, a count, an orientation, and a type of the at least one inventory item, wherein the determination is based on the difference between the reflected and detection signals. In one example, after performing this step, the determination may be stored on computer-readable memory. In another example, Step 350 may include the steps of learning determination rules from a set of “training” reflected millimeter wave signals (hereinafter, “training signals”) stored on computer-readable memory, and applying at least one determination rule to the received reflected millimeter wave signal to make the determination. Alternatively, the training signals may be received by the transmitter and used to train the processor. This is described further in FIG. 4, below.

Step 360 includes calculating, with the processor, a confidence level for the determination. The process of calculating a confidence level is described further in FIG. 5, below.

Step 370 includes communicating, with a transmitter in communication with the processor, at least a portion of the determination and the confidence level to a database. The database may be a cloud database, local network, or other computer storage.

The method of inventorying a commercial facility may be repeated several times, in full or in part, to inventory the desired portion of the commercial facility. This may depend on multiple factors, for instance, the field of view and resolution of the apparatus 1 or scanning device, the size of the facility, the nature of the items being inventoried, and the like. A user may initiate scans at several points throughout the facility. For example, a user using a handheld embodiment as in FIG. 2A may scan a single shelf using steps 310-360, repeat those steps on the next shelf, and continue repeating steps 310-360 until a full aisle has been scanned. The user may then perform step 370 to communicate the determination and confidence level to the database. In another example, the fixed embodiment of FIG. 2B capable of rotating 360° may have a larger field of view (FOV), and may only perform steps 310-360 a few times as it scans an entire aisle. Or the fixed embodiment may perform the steps many times more in order to receive more granular results. In another example, the robotic embodiment of FIG. 2C may perform the entire method hundreds of times as it travels along aisles of shelves in the commercial facility, receiving constant feedback about the quality of its calculations.

The location and frequency of scans may be determined by the user. For example, the user may adjust settings on the apparatus for scanning device to perform scans in a desired manner. The user may adjust the frequency of the signal, FOV of the sensor, sensitivity, and the like. The location and frequency of scans may alternatively be determined by the processor. Based on the system limitations—FOV, angular resolution, processing speed, memory read/write speeds, etc.—the processor may instruct the user to perform more or fewer scans in certain parts of the facility or when detecting certain inventory items. The processor may use location detection to establish waypoints where scans must be performed.

In one example, the apparatus 1 or scanning device may perform several scans in rapid succession in order to stack the processed signals or perform superresolution processing. In stacking, multiple processed signals captured from the same location may be overlaid and further processed to reduce noise and increase signal contrast. In superresolution, multiple reflected signals may be received as the receiver moves slightly or with multiple receivers slightly offset from each other, creating small shifts in the temporal or spatial characteristics of the reflected signals. The combined processed signals may resolve finer details than individual signals alone. Stacking or superresolution imaging may be chosen by either the user or the processor, depending on the intended inventory items or use conditions.

FIG. 4 is a flow chart 401 showing an exemplary process for determining the inventory characteristics of at least one inventory item, in accordance with a second embodiment of the disclosure. The process will be discussed relative to FIGS. 1-4.

Step 400 includes receiving one or more reflected signals 22. The reflected signals 22 may include continuous or discrete chirps initially transmitted by the transmitter 10.

Step 410 includes initial signal processing. The transmitted and reflected signals 12, 22 are directed to the processor 30. In one example, they may be combined by the mixer 36, which may perform basic signal processing operations such as adding, subtracting, time-shifting, and the like, as discussed above. These operations may reduce noise or otherwise prepare the signals, alone or combined, for processing. In another example, the signals 12, 22 may pass through an analog-to-digital converter (ADC) to prepare them to be read by the processor 30. The processor 30 may perform some initial syncing operations as well. Any other signal processing techniques commonly known in the art may be performed during this step.

Step 420 includes extracting details using computer vision. Computer vision may include the use of signal thresholding and contour detection to determine where discrete inventory items 4 are located or how they are oriented. Additional signal processing operators, such as Scharr operators resulting from an optimization minimizing a weighted mean squared angular error in the Fourier domain, may be used to detect inventory item edges. Regions with contrasting mean gradients may be identified. High frequency noise may be smoothed from the gradient signal image plane. Morphological operators may be applied on the thresholded signal. This step may focus on processing only portions of the total FOV that are helpful for detecting and differentiating inventory items.

Step 430 includes using a classification approach to assist in inventory characteristic detection. Generally, this kind of image processing uses a set of signals to train the processor 30 to detect stock items, orientation, count, and location. The processor 30 may be given signals indicative of certain items, certain arrangements of items, items in stock, items out of stock, and similar variations. The processor 30 may use these training signals to learn the characteristic qualities of the item 4 or the level of stock. With each subsequent viewing, the processor 30 learns more about the characteristic qualities. The training data may be stored in on-board memory 32, transmitted from the database 40, or developed from previous scans run by the apparatus 1. Some combination of all training data may be used to develop robust detection rules for the processor 30.

The processor 30 may initially train by applying machine learning techniques to a set of training signals. The training signals may show generic signal examples, and the processor 30 may learn to recognize inventory characteristics based on relationships between like signal sets. The training signals may be customized for certain conditions in a particular facility, which may help the apparatus 1 learn more efficiently.

The classification approach may use the training signals to build classifiers that help it recognize items. Classifiers may be managed at different hierarchical levels to detect stock and recognize products. For instance, classifier levels may include, but are not limited to: data from all stores, data from a single store, data from a single department across all stores, data in a single department in a single store, data for a particular product category across all stores, and data for a particular product category in a single store. After the classifiers are built, they may be improved using captured image data or data from previous results.

Steps 432, 434, 436, and 438 show other approaches that may be used in detecting inventory items 4 and determining inventory characteristics. In step 432, a detection approach may be used to identify whether any items are out of stock by considering, without considering every single detected inventory item 4, whether there appear to be any items out of stock. The detection approach uses the received signals 22 as a whole to train a classifier which determines the location of an item and whether any stock is missing. In step 434, a product recognition approach may use unique signal characteristics to create product categories. For example, if a particular inventory item 4 always returns a reflected signal 22 with a particular amplitude modulation or a unique peak frequency, the processor 30 may use this to create a category for that item. Product categories can assist in building classifiers using neural network, machine learning, or deep learning techniques. In step 436, an educated estimation approach may compare processed signals from previous inventory scans to the current inventory scans in order to determine how much stock remains. In step 438, a heuristic identification process may be used to identify an item by the details extracted from the computer vision process 420. The heuristic process compares previous signals captured under similar conditions, such as location in the facility or distance from the item, to the current signals, comparing detected features and other data.

It is noted that the processes described herein may be used with multiple signal images compiled together, so-called “image stitching”. Image stitching may be implemented to account for the regions of an image that are close to the borders of the FOV, in order to increase the usable area of a signal scan. For instance, if an item 4 is located between the opposite borders of two adjacent scans, for instance, between the left border of one scan and the right border of the next scan, the processor 30 may stitch the images together and extract the inventory information from the combined signal image.

As shown in box 440, these processes can be used to determine inventory characteristics for detected inventory items 4. The processor 30 may use one or more of the classification processes, in conjunction with the computer vision and other signal processing operations, to discover pieces of inventory characteristics or patterns during the scan. The processor 30 may combine the pieces or patterns, giving some pieces more weight, to determine the desired inventory characteristics.

For example, using the locations of detected edges and contours, the processor 30 may determine where items are located on a shelf or in an aisle. Additionally, the processor 30 may use the locations of detected edges and contours to determine orientation by associating certain edge or contour patterns with certain orientations.

In another example, the apparatus 1 can determine stock quantity data using additional imaging sensors, such as visual cameras, radar, sonar, or LIDAR sensors in combination with processing already described. This may be useful in helping the processor 30 identify items that are difficult to distinguish using millimeter waves, such as items that have substantially similar shapes. In yet another example, the apparatus 1 may use multiple sensors in sequence to improve captured data. For instance, the apparatus 1 may be equipped with millimeter wave and image sensors, with one sensor configured to scan first. Based on the results of the first scan, the other sensor may focus in on particular areas for increased resolving power, noise removal, or other analysis.

FIG. 5 is a flow chart 501 showing an exemplary process for determining a confidence level for the inventory information using the apparatus of FIG. 1. The confidence level indicates how accurate the processor 30 believes the determined inventory characteristics to be.

In step 500, the apparatus 1 receives a reflected signal. In step 510, the apparatus 1 determines any desired inventory characteristics. In step 520, the apparatus 1 calculates a confidence level for the determination. The confidence level may be determined by a number of factors, as shown in steps 521-525, including captured signal quality, the type of items detected, the number of items detected, the stock status of the items, and similarity to historic results, respectively. Other factors known to those of skill in the art may be considered. In one example, the processor 30 may assign a higher confidence level for signals received with optimal noise levels, or signals clearly indicating one or more inventory items 4. The processor 30 may assign a lower confidence level for noisy or incomplete signals, or where items 4 are located too close together to distinguish. Similarly, the processor 30 may assign a higher confidence level for images where the type and number of products can be accurately determined, while assigning a lower confidence level where the processor 30 cannot make a determination. For example, where the detected inventory items 4 have unique characteristics, the confidence level may be higher. Further, the processor 30 may assign a higher confidence level where the determined inventory characteristics are similar to historically determined inventory characteristics, but assign a lower confidence level where the determined inventory characteristics vary in a statistically significant way. In one example, the processor 30 may use some combination of these factors in determining the confidence level. Some factors may be considered more or less heavily, i.e., given weights, depending on the presence and extent of the factors.

In step 530, inventory characteristics with a confidence level above a threshold may be communicated to the database 40, as shown in box 550. This information may automatically be entered. This threshold may be the same for all items in a commercial facility, or it may differ from item to item. For example, an extremely high confidence level may be desired for expensive, high margin items, or items prone to theft. A lower confidence level may be acceptable for less expensive or low margin items, as there may be too great a trade-off between accuracy and the effort required for accuracy. Threshold confidence levels may be determined by the processor 30, the database 40, facility owners, or other software. Threshold confidence levels may be changed on occasion, for example, seasonally.

In step 540, inventory characteristics with a confidence level below a threshold may not be automatically entered by the database. In step 542, inventory characteristic determinations with a confidence level below a threshold may be passed to a user for additional analysis or confirmation of results. The user may use signals from other sensors, if present, to manually verify inventory location, count, orientation, or type, as shown in box 544. The user may then direct the database 40 to enter the inventory characteristics, as shown in step 550. Alternatively, as shown in step 546, the user may send the signal back to the apparatus 1 for additional processing and further communication to the inventory database 40. In one example, inventory characteristics with a confidence level below a threshold may require the apparatus 1 to capture additional signal data for the subject inventory items 4. The apparatus 1 may perform another scan of the relevant area. The subsequent signals may be processed and compared with the original signals for confirmation of results. As shown in step 548, inventory characteristics with a confidence level below a threshold may also require the user to physically verify the results. The user may check the inventory status and report it to the database 40, which may compare the inventory status with the original inventory characteristics and submit that to the database.

In one example, the apparatus 1 may learn inventory characteristics from scans that resulted in low confidence levels. The processor 30 may use these scans to understand why the confidence levels fell below a threshold and develop rules that will lead to increased confidence levels. The apparatus 1 may learn inventory characteristics from scans confirmed by a user. The processor 30 may develop rules to understand why the user made a particular decision. In another example, the apparatus 1 may learn inventory characteristics from scans performed by other apparatuses within its network. To this end, the database 40 may identify and make available scans that are particularly helpful in apparatus learning.

In another example, the database 40 may include an analytics system, e-commerce system, or other end-user systems for processing and utilizing the scanned inventory characteristics.

The analytics system may provide detailed analysis of inventory information for human end users. Planogram analytics may be used to analyze inventory layout plans for improvements. Inventor analytics may be used to analyze ordering patterns for effectiveness. Pricing analytics may be used to compare the prices of available inventory to competitors. Response analytics can be used to analyze a facility's response to low inventory events, theft, and discrepancies.

The e-commerce system may provide a platform for interact sales of items located within the facility. The database 40 may maintain inventory and location data for every item in a commercial facility, or across multiple facilities. E-commerce customers seeking to purchase items may interact with the database 40, which may search for in-stock items and provide location data to customers.

A theft tracking system may allow a facility to track every item in the facility in real time. For example, the facility may be constantly scanned by several apparatuses placed to provide full coverage of the facility. As items are moved throughout the facility, an apparatus 1 may detect the motion and track the item's location. The apparatus may report this to a theft tracking system on the database 40, which coordinates the other apparatuses to track the item as well. At an appropriate point, loss prevention teams may be alerted to investigate items that are moving suspiciously.

Database systems may be accessed using a graphical interface through a software implication or a website. The interlace may work with a virtual model of the shelves and aisles in facility, such as a “master-shell” model which maintains a virtual representation of all of the inventory information communicated to the database. The virtual model may not be a visual representation, but may be primarily a numerical representation of the inventory. The virtual model may be updated each time the apparatus 1 communicates new information to the database 40.

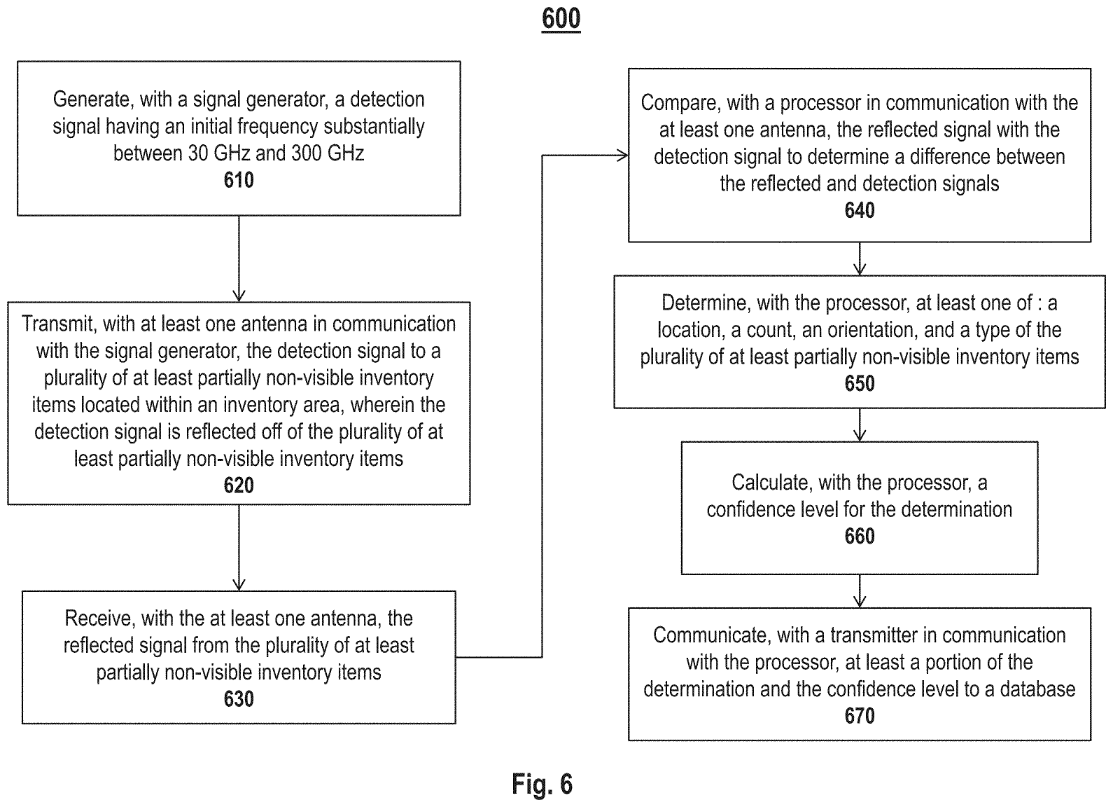

FIG. 6 is a flow chart 600 showing a method of inventorying at least partially non-visible items in accordance with a third embodiment of the disclosure. The method may be performed with the apparatus 1 of FIG. 1 and any of the exemplary embodiments of FIGS. 2A-2C, or it may be performed using other suitable hardware and software components.

Step 610 includes generating a detection signal. The detection signal has an initial frequency substantially between 30 GHz and 300 GHz and is a millimeter wave signal.

Step 620 includes transmitting the detection signal to a plurality of at least partially non-visible inventory items located thin an inventory area, wherein the detection signal is reflected off of the plurality of at least partially non-visible inventory items. The detection signal is transmitted using at least one suitable antenna in communication with the signal generator.

Non-visible inventory items may be any inventory items described above which are visually obscured or difficult to see. For instance, non-visible inventory items may be products located in product packaging, shipping packaging, delivery vehicles, and the like. Such inventory items may not be visible to the human eye, as packaging materials generally obscure them. However, millimeter waves may be able to propagate through packing materials and reflect off of the inventory items. Non-visible inventory items may additionally be items obscured by their placement, for example, items located on high or dark shelving. Millimeter waves may propagate through shelving. Non-visible inventory items may additionally be items commonly grouped closely together, such as screws and other hardware. It may be difficult for humans to visually count such items, but millimeter waves may be able to resolve them. At least partially non-visible inventory items are those items that are partially or completely obscured for any of the above reasons.

An inventory area may be any area, whether within a facility or other location, in which non-visible inventory items are located. For example, this may be a shipping box, pallet, shelf, aisle, or display. This may also be a shopping cart, shopping bag, storage container, and the like.

Step 630 includes receiving the reflected signal from the plurality of at least partially non-visible inventory items. The reflected signal may be received with any number of suitable antennas.

Step 640 includes comparing, with a processor in communication with the at least one antenna, the reflected signal with the detection signal to determine a difference between the reflected and detection signals.

Step 650 includes determining, with the processor, at least one of: a location, a count, an orientation, and a type of the plurality of at least partially non-visible inventory items.

Step 660 includes calculating, with the processor, a confidence level for the determination.

Step 670 includes communicating at least a portion of the determination and the confidence level to a database. A transmitter in communication with the processor may transmit the determination and the confidence level.

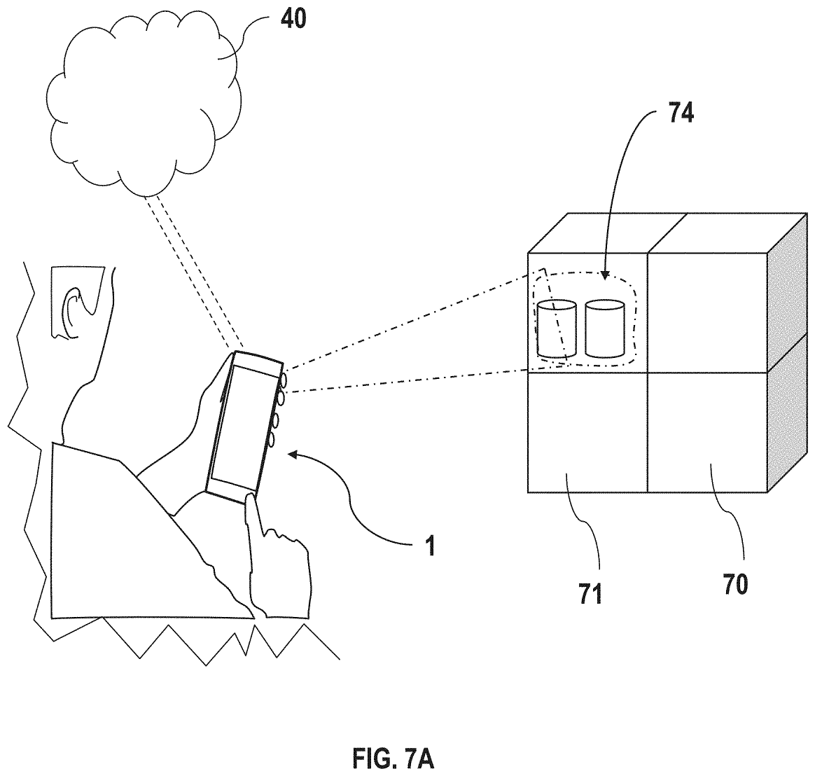

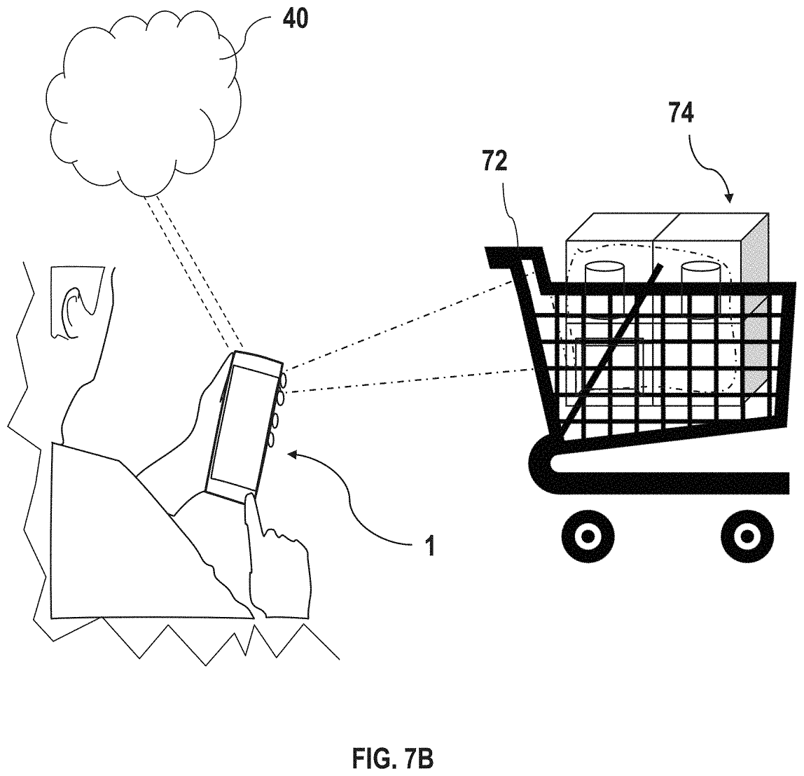

FIGS. 7A-7B show exemplary embodiments of the method of FIG. 6 in use to inventory at least partially non-visible items.

FIG. 7A shows a user with a handheld apparatus 1 performing an inventory analysis on items 74 located within shipping packaging. The several items 74 may be included in each box 70, but may not be visible to the user. The user may scan the boxes using the apparatus 1 and the method of FIG. 6 to determine the characteristics of the inventory contained therein. The results of the scan, along with the confidence level, may be transmitted to a cloud database 40.

The apparatus 1 may scan a single box 70 or multiple boxes at the same time. In one example, the user may hold the apparatus 1 still while performing a scan. The apparatus 1 may scan the maximum area allowed by its FOV and may calculate results based on that area. In another example, the user may move or sweep the apparatus 1 to allow it to scan the entire desired inventory area. Motion sensors, such as accelerometers, may detect the motion and communicate this to the processor 30, allowing the processor 30 to compensate for the motion during signal processing. The apparatus 1 may include a visual indication of the area being scanned. For instance, the apparatus 1 may include a visible light that shines on the area being scanned, allowing a user to confirm that the desired area is covered. In embodiments with a display, the display may indicate the area being scanned. For instance, a mobile device such as a smartphone may take a picture of the scanned area and display that on the screen as the apparatus 1 scans with millimeter waves.

In another example, the apparatus 1 may be able to distinguish between different packages, boxes, or other materials. For instance, the apparatus 1 may use the spacing of detected inventory items 74 or visual contour/edge detection to determine that box 70 is different from the next adjacent box 71. The processor 30 may use this to determine whether a box or other inventory area has an appropriate number of inventory items 74. For example, if box 70 should contain 12 inventory items 74, and box 71 should contain 24 items, the processor may distinguish between the boxes 70, 71 and report the inventory characteristics accordingly.

FIG. 7B shows a user with a handheld apparatus 1 performing an inventory analysis on items 74 in a shopping cart 72. As an example, a customer shopping in a store may place several items in a cart 72 with the intention of purchasing them. Instead of a store associate scanning each item individually on a conveyor belt or in a checkout lane, the associate may simply use the apparatus 1 to scan the items in the cart 72. Even though it may be difficult for the associate to visually identify every item, the apparatus 1 may detect each item contained within the cart 72.

Other embodiments of the apparatus 1 may be useful for this kind of inventory analysis. For example, the fixed embodiment shown in FIG. 2B may be located on a wall or ceiling near the exit of a store, and may scan customers' carts as they exit the building. Or a fixed embodiment may be located in the cart 72, scanning each item as it is placed into or taken out of the cart. Alternatively, a fixed embodiment may be located on a shelf or display, tracking items as they are taken off the shelf and placed into a cart. In such cases, the apparatus 1 may communicate inventory movement to a network in communication with the customer so that the customer can be charged appropriately.

This type of inventory analysis may also be useful in warehouses or other non-retail facilities. An apparatus 1 may scan items being transported by an employee through the facility to maintain accurate records of the items. For instance, an apparatus 1 may scan the contents of a pallet being moved by an employee driving a forklift in order to verify that the appropriate number and type of items were being moved. Or an apparatus 1 may scan the contents of a shipping truck as it leaves or arrives at a facility to confirm that the shipment is correct.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure.

All such modifications and variations are intended to be included herein within the scope of the present disclosure and protected by the following claims.

What is claimed is:

1. An apparatus comprising:
a signal generator, generating a millimeter wave signal having an initial frequency substantially between 30 GHz and 300 GHz;
a transmitter, transmitting the millimeter wave signal to at least one inventory item in a commercial facility, wherein the transmitted millimeter wave signal is reflected off of the at least one inventory item, and wherein the transmitter is in communication with the signal generator;
a receiver, receiving a reflected millimeter wave signal from the at least one inventory item; and
a processor in communication with the receiver and the signal generator, wherein the processor determines at least one of: a location, a count, an orientation, and a type of the at least one inventory item using the reflected millimeter wave signal, wherein the determination is based on a comparison of the reflected millimeter wave signal with the transmitted millimeter wave signal.

2. The apparatus of claim 1, wherein the millimeter wave signal further has at least a second frequency different from the initial frequency.

3. The apparatus of claim 1, wherein the comparison of the reflected millimeter wave signal with the transmitted millimeter wave signal is a difference of at least one of: phase, amplitude, polarization state, and frequency.

4. The apparatus of claim 1, further comprising a set of training reflected millimeter wave signals stored on computer-readable memory in communication with the processor, wherein the processor is trained to make the determination based on rules learned from the set of training reflected millimeter wave signals.

5. The apparatus of claim 1, further comprising an information transmitter in communication with the processor, wherein the processor communicates at least a portion of the determination to a database using the information transmitter.

6. The apparatus of claim 5, wherein the processor further calculates a confidence level of the determination, and wherein the apparatus communicates the confidence level to a database using the information transmitter.

7. A method of inventorying at least a portion of a quantity of inventory items in a commercial facility with an electronic inventory apparatus, the method comprising the steps of:
generating, with a signal generator, a detection signal having an initial frequency substantially between 30 GHz and 300 GHz;
transmitting, with at least one antenna in communication with the signal generator, the detection signal to at least one inventory item;
receiving, with the at least one antenna, a reflected signal from the at least one inventory item;
comparing, with a processor in communication with the at least one antenna, the reflected signal with the detection signal to determine a difference between the reflected and detection signals;
determining, with the processor, at least one of: a location, a count, an orientation, and a type of the at least one inventory item, wherein the determination is made based on the difference between the reflected and detection signals;
calculating, with the processor, a confidence level for the determination; and
communicating, with a transmitter in communication with the processor, at least a portion of the determination and the confidence level to a database.

8. The method of claim 7, wherein the millimeter wave signal further has at least a second frequency different from the initial frequency.

9. The method of claim 7, wherein the comparison of the reflected millimeter wave signal and the transmitted millimeter wave signal is the difference of at least one of: phase, amplitude, polarization state, and frequency.

10. The method of claim 7, wherein the step of determining at least one of a location, count, orientation, and type of the at least one inventory item comprises:
learning determination rules from a set of training reflected millimeter wave signals stored on computer-readable memory in communication with the processor; and
applying at least one determination rule to the received reflected millimeter wave signal to make the determination.

11. The method of claim 7, wherein the detection signal comprises a plurality of chirps.

12. The method of claim 7, wherein the steps of transmitting the detection signal and receiving a reflected signal are performed with different antennas.

13. A method of inventorying at least partially non-visible inventory items, comprising:
generating, with a signal generator, a detection signal having an initial frequency substantially between 30 GHz and 300 GHz;
transmitting, with at least one antenna in communication with the signal generator, the detection signal to a plurality of at least partially non-visible inventory items located within an inventory area, wherein the detection signal is reflected off of the plurality of at least partially non-visible inventory items;
receiving, with the at least one antenna, the reflected signal from the plurality of at least partially non-visible inventory items;
comparing, with a processor in communication with the at least one antenna, the reflected signal with the detection signal to determine a difference between the reflected and detection signals;
determining, with the processor, at least one of: a location, a count, an orientation, and a type of the plurality of at least partially non-visible inventory items;
calculating, with the processor, a confidence level for the determination; and
communicating, with a transmitter n communication with the processor, at least a portion of the determination and the confidence level to a database.

14. The method of claim 13, wherein the millimeter wave signal further has at least a second frequency different from the initial frequency.

15. The method of claim 13, wherein the comparison of the reflected millimeter wave signal and the transmitted millimeter wave signal is the difference of at least one of: phase, amplitude, polarization state, and frequency.

16. The method of claim 13, wherein the step of determining at least one of a location, a count, an orientation, and a type of the at least one inventory item comprises:
learning determination rules from a set of training reflected millimeter wave signals stored on computer-readable memory in communication with the processor; and
applying at least one determination rule to the received reflected millimeter wave signal to make the determination.

17. The method of claim 13, wherein the detection signal comprises a plurality of chirps.

18. The method of claim 13, wherein the steps of transmitting the detection signal and receiving a reflected signal are performed with different antennas.

19. The method of claim 13, wherein the inventory area is one of: a package, a display area, a storage area, a transportation area, and a purchase area.

20. The method of claim 13, wherein the inventory area is a shipping vehicle.
